(19) United States
(12) Patent Application Publication
(10) Pub. No.: US 2020/0191662 A1
(43) Pub. Date: Jun. 18, 2020

(54) SECURING METHOD, SECURING DEVICE, USE OF A SECURING DEVICE AND TEMPERATURE SENSOR

(71) Applicant: FOS4X GMBH, München (DE)

(72) Inventors: Tobias MÖLLER, Starnberg (DE); Sascha KIENITZ, Munich (DE)

(21) Appl. No.: 16/643,481

(22) PCT Filed: Aug. 10, 2018
(86) PCT No.: PCT/EP2018/071789

§ 371 Date: Feb. 28, 2020

(30) Foreign Application Priority Data
Aug. 31, 2017 (DE) 102017120062.2

(51) Int. Cl. G01K 11/32; G02B 6/02

(52) U.S. Cl. CPC G01K 11/3206; G02B 6/0218

(57) ABSTRACT

The invention relates to a securing method, comprising the following Steps: providing an optical waveguide made of a material with a first melting temperature, wherein a sensor region of the optical waveguide has at least one integrated temperature sensor element; providing a capillary made of a material with a second melting temperature, in such a way that the capillary surrounds at least regions of the sensor region of the optical waveguide, and that a securing region of the capillary is arranged at a distance from the sensor region, wherein the second melting temperature is lower than the first melting temperature, wherein the temperature sensor element is arranged in an end region of the optical waveguide, and the end region is inserted into the capillary; securing the securing region of the capillary to the optical waveguide, involving a heating of the securing region of the capillary to a heating temperature that is equal to or higher than the second melting temperature; and heating the free end of the capillary to a heating temperature that is equal to or higher than the second melting temperature. A temperature sensor comprising an optical waveguide with at least one integrated temperature sensor element can be obtained with the method. A securing device comprises an Insertion region for the capillary, a detector and a heating region. The securing device can be used for carrying out the method.

### TECHNICAL FIELD

Embodiments of the disclosure relate to a securing method, a securing device, use of a securing device for carrying out a securing method, as well as a temperature sensor which can be obtained by a securing method.

A fiber Bragg grating integrated into an optical waveguide can be used as a temperature sensor. A thermally induced length change of the fiber Bragg grating causes the spectral reflection maximum of the grating to be shifted. By supplying light to the grating and evaluating the reflection maximum, conclusions as to the temperature of the grating may be drawn.

### STATE OF THE ART

Apart from the temperature sensitivity desired for measuring temperature, a fiber Bragg grating sensor is also sensitive to other mechanical strains and compressions in the form of external disturbances. This sensitivity to external disturbances needs to be decoupled mechanically. One possibility is to surround the area of the optical waveguide, where the fiber Bragg grating is formed, with a capillary, and to secure this capillary mechanically to the optical waveguide.

It is known to use an adhesive for securing the capillary to the optical waveguide. The fiber is bonded into the capillary, which, however, could adversely affect the temperature sensitivity. Furthermore, the bonding might advance up to the fiber Bragg grating and clog this area which may result in a functional failure.

Moreover, methods for mechanically securing a capillary to an area of an optical waveguide are known, in which the optical path of the optical waveguide is directly spliced with a fused silica capillary. US 2002/0009279 A1 discloses an optical single mode fiber with a fiber Bragg grating, wherein a sheath is connected to an area of the fiber by heat treatment, in which area the outer diameter of the fiber is enlarged.

This entails a strong and undesired signal attenuation and thus a deterioration of the measurement signals. A solution is desired, in which the reliability of a mechanical connection between an optical waveguide and a capillary is ensured at simultaneously good temperature sensitivity and/or low signal attenuation.

### SUMMARY OF THE DISCLOSURE

Embodiments of the present disclosure provide a securing method having the features of claim 1. Further, embodiments of the present disclosure propose a securing device having the features of claim 10. Furthermore, embodiments of the present disclosure propose a use of the securing device disclosed herein for carrying out a method disclosed herein. Moreover, embodiments of the present disclosure propose an optical waveguide comprising at least one integrated temperature sensor element, wherein the temperature sensor can be obtained by a method described herein.

According to an embodiment, a securing method is proposed comprising the following steps: providing an optical waveguide made of a material with a first melting temperature, wherein a sensor region of the optical waveguide has at least one integrated temperature sensor element; providing a capillary made of a material with a second melting temperature, in such a way that the capillary surrounds at least regions of the sensor region of the optical waveguide, and that a securing region of the capillary is arranged at a distance from the sensor region, wherein the second melting temperature is lower than the first melting temperature, wherein the temperature sensor element is arranged in an end region of the optical waveguide, and the end region is inserted in the capillary so that an end of the capillary is exposed; securing the securing region of the capillary to the optical waveguide, involving a heating of the securing region of the capillary to a heating temperature that is equal to or higher than the second melting temperature; and heating the exposed end of the capillary to a heating temperature that is equal to or higher than the second melting temperature.

A securing device disclosed herein comprises: an insertion region for a capillary surrounding a sensor region of an optical waveguide at least in regions, wherein the capillary comprises a sensor region that can be arranged at a distance from the sensor region of the optical waveguide; a detector configured to detect a marking on the capillary which is provided on the capillary in order to indicate the securing region of the capillary; and a heating region configured to heat the securing region of the capillary, preferably to heat it automatically for a predetermined period of time when the detector detects the heating region.

In embodiments, the securing device described herein is used for carrying out the securing method described herein.

In embodiments, a temperature sensor is obtained, in which a securing method described herein is implemented. For carrying out the securing method, a securing device described herein may in turn be used. The obtained temperature sensor has an optical waveguide, which for its part in turn has an integrated temperature sensor element.

A temperature sensor element integrated into an optical waveguide along the axial direction typically is a fiber Bragg grating. A fiber Bragg grating is an optical interference filter reflecting light having a determined wavelength or light which is within a determined wavelength range. The determined wavelength or the determined wavelength range is influenced by an elongation or compression of the fiber Bragg grating in the axial direction of the optical waveguide. Measurement light impinging on the fiber Bragg grating is reflected depending on its wavelength, or only wavelength portions of the measurement light are reflected by the grating which are within a reflection bandwidth of the grating. The wavelength dependency may be influenced by the elongation or compression.

In order to preponderantly measure a temperature-induced elongation or compression of the region of the optical waveguide containing the fiber Bragg grating, this region (referred to as a sensor region in the following) of the optical waveguide is mechanically decoupled by the method described herein.

Due to the fact that only the capillary is melted, the optical path of the optical waveguide is not or not significantly influenced, and substantially no additional signal attenuation is caused by the securing method.

Due to the fact that the exposed end of the capillary is heated to a heating temperature that is equal to or higher than the second melting temperature, also the end facing the heating region is correspondingly sealed so that an intrusion of foreign material into the interior of the capillary can be avoided.

The method moreover is free from adhesive. This allows an influence of the temperature behavior by adhesive, which is used in conventional methods, to be avoided. In addition, the operating temperature may also be above a range in which adhesive conventionally used for securing would not be operational. Due to the absence of adhesive, adhesive may not creep into the region of the temperature sensor element and affect the temperature sensor element.

The connection between the capillary and the optical waveguide is performed according to the method by a splicing operation. By melting the capillary in the securing region in a targeted manner, the securing region of the capillary changes its inner diameter at least in sections. The securing region gets in mechanical contact with the optical waveguide and holds the optical waveguide in position by friction. Due to the fact that the securing region is at a distance from the sensor region of the optical waveguide, the sensor region is not influenced substantially. As a result, the connection is free from adhesive and tight.

For carrying out the method, a splicing device is used, for example, to heat the defined point on the capillary, which corresponds to the securing region, to the heating temperature. Thereby (only) the capillary melts and subsequently cures in the deformed state in which it has a mechanical contact with the optical waveguide. The optical path of the optical waveguide is thereby not or not significantly affected.

A non-restrictive example of the material of the capillary is borosilicate. A non-restrictive example of the material of the optical waveguide is glass fiber (silicon dioxide). The first melting temperature, i.e. that of the optical waveguide, then is at about 1000° C. The second melting temperature, i.e. that of the capillary, then is at about 700° C.

In embodiments, the heating temperature is lower than the first melting temperature. This allows in a simple manner to ensure that the material of the optical waveguide remains in the non-molten state during the securing operation and thus the optical path is not affected. The heating temperature, which, according to the embodiment, is lower than the first melting temperature, is at least the heating temperature by which the securing region of the capillary is heated. In addition, also the heating temperature, which, according to the embodiment, is lower than the first melting temperature, may also be the heating temperature by which the exposed end of the capillary is heated.

In embodiments, the securing further comprises heating the securing region to the heating temperature during a period of time of a predetermined duration; and subsequently allowing the securing region to cool down. This may ensure the capillary to be reliably connected to the optical waveguide and to reliably remain in its position after the securing operation has been completed.

It is also possible that the heating temperature is selected to be equal to or higher than the first melting temperature. According to this aspect the heating of the securing region of the capillary to the heating temperature is performed during a period of time of a predetermined duration, wherein the predetermined duration of the period of time is selected such that the material of the optical waveguide during securing is heated to a temperature that is lower than the first melting temperature. Subsequently, the securing region is allowed to cool down.

Selecting the period of time according to this aspect ensures that the heat may not spread to the optical waveguide such that the optical waveguide melts. According to this aspect, a faster securing operation can be achieved.

In embodiments, the securing further comprises temporarily fixing the securing region prior to heating, in fact relative to at least the axial direction of the optical waveguide. After allowing to cool down, the fixing is released.

Thereby, it can be guaranteed that the capillary will not displace along the axis of the optical waveguide prior to being connected to the optical waveguide in a friction-fit manner by cooling down, so that the optical properties of the optical waveguide will not be affected by an unintended displacement.

In embodiments, the predetermined duration of time is at least so long that at a given diameter, a given material thickness and a given elongation of the securing region in the axial direction, the material of the capillary melts in the securing region. In addition, the predetermined duration of time is at maximum so long that the material of the optical waveguide remains in the non-molten state.

Thereby, it can be guaranteed that the connection between the securing region of the capillary and the optical waveguide is secure and reliable.

In embodiments, the predetermined duration of time is at maximum so long that a region of the capillary surrounding the sensor region of the optical waveguide remains in the non-molten state.

Thereby, it can be guaranteed that the sensor region of the optical waveguide or the temperature sensor element contained therein remains largely uninfluenced by molten capillary material, so that the optical properties are not affected.

In embodiments, the securing region of the capillary is provided to be circumferential around an axis of the capillary, and, after securing, the securing region circumferentially abuts against the peripheral surface of the optical waveguide in a friction-fit manner. As an alternative or in addition, the securing region according to this aspect circumferentially abuts against the peripheral surface of the optical waveguide in a sealing manner.

The circumferentially ensured friction fit allows the capillary to be fixed to the optical waveguide in a secure manner. A circumferential sealing may contribute to avoid an intrusion of foreign material into the interior of the capillary.

In embodiments, the securing region of the capillary has at least one axial elongation which is suitable to withstand a predetermined force in the axial direction between the capillary and the optical waveguide after securing.

### BRIEF DESCRIPTION OF THE DRAWINGS

Embodiments of the invention are illustrated in the drawings and explained in more detail in the description below. Shown are in the drawings:

FIG. 1 a schematic representation of an optical waveguide and a capillary for explaining a securing device according to an embodiment;

FIG. 2 a schematic representation of the optical waveguide and the capillary of FIG. 1 on a securing device suitable for carrying out a securing method according to an embodiment;

FIG. 3 a flow chart of a securing method according to an embodiment.

Embodiments of the invention will be explained in more detail below. The drawings serve the purpose of depicting one or more examples of embodiments of the invention.

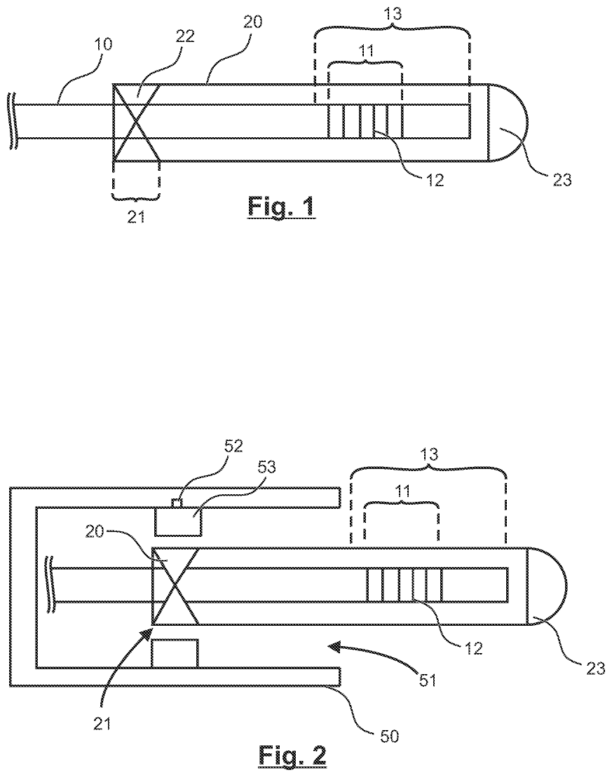

FIG. 1 shows a schematic representation of an optical waveguide 10 with a sensor region 11 arranged at the end side. In the sensor region 11 provided in an end region 13 of the optical waveguide 10, a fiber Bragg grating is formed by way of example as a temperature sensor element 12. The optical waveguide 10 of the embodiment is formed as a non-restrictive example from SiO₂ with a first melting temperature of about 1000° C.

A capillary 20 formed as a non-restrictive example from borosilicate with a second melting temperature of about 700° C., surrounds the sensor region 11 of the optical waveguide 10 circumferentially. The capillary 20 extends in an axial direction of the optical waveguide 10 away from the end region 13 and has a securing region 21 in a portion situated at a certain distance from the sensor region 11 of the optical waveguide 10. By way of example, a marking 22 is applied to the securing region 21. The marking 22 may be optical, but alternatively or additionally may also be machine-detectable, for example, magnetic or the like.

FIG. 2 shows the optical waveguide 10 with the capillary 20 on a schematically illustrated securing device 50 which, by way of example, may be used for carrying out the method. The securing device 50 comprises an insertion region 51 for the capillary 20, a detector 52 configured to detect the marking 22 on the capillary 20, as well as a heating region 53 configured to heat the securing region 21 of the capillary 20 when the detector 52 has detected the marking 22 and has determined its position, if necessary.

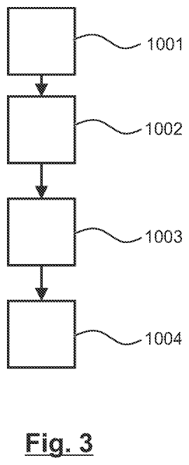

An embodiment of the method is explained using the flow chart of FIG. 3 with further reference to FIGS. 1 and 2.

In 1001, the optical waveguide 10 is provided. The optical waveguide 10 is made of a material with a first melting temperature. A sensor region of the optical waveguide 10 comprises the fiber Bragg grating as an integrated temperature sensor element 12.

In 1002, the capillary 20 is provided such that the capillary 20 surrounds the sensor region 11 of the optical waveguide 10 at least in regions, and that the securing region 21 of the capillary 20 is at an axial distance from the sensor region 11. The capillary 20 has a second melting temperature which is lower than the first melting temperature of the optical waveguide 10.

In 1003, the securing region 21 of the capillary 20 is secured to the optical waveguide 10. During securing, the securing region 21 of the capillary 20 is heated to a heating temperature. The heating temperature is equal to or higher than the second melting temperature. The heating is performed, for example, by the heating region 53 of the securing device 50.

In the embodiment, moreover, an exposed end 23 of the capillary is heated to a heating temperature in 1004, which is equal to or higher than the second melting temperature. The heating of the exposed end 23 may likewise be performed by the heating region 53 of the securing device 50. A further marking (not shown) may be provided at the exposed end 23 of the capillary 20, which the detector 52 detects and causes the heating region 53 after a corresponding positional determination, if necessary, to heat the exposed end 23 in the region of the further marking. It may also be provided for the detector 52 to detect the end of the capillary 20 (the exposed end 23) without a marking and to cause the heating region 53 there to heat the exposed end 23. It may also be provided for the exposed end 23 to be heated without detection, for example, by an externally performed positioning of the heating region 53.

Thereby, a temperature sensor is obtained whose temperature sensor element 12 is largely decoupled from undesired mechanical influence by means of the capillary 20. Free from adhesive, the capillary 20 is reliably connected by means of friction to the optical waveguide 10 by its securing region 21 and is sealed circumferentially. At the exposed end 23, the tightness is moreover guaranteed by the heating operation.

It should be noted at this point that the aspects and embodiments described herein can be appropriately combined with one another, and that single aspects may be omitted where it is reasonable and possible withing the scope of skilled action. The skilled person will be familiar with modifications and additions to the aspects described herein.

1. A securing method, comprising:
providing an optical waveguide made of a material with a first melting temperature, wherein a sensor region of the optical waveguide comprises at least one integrated temperature sensor element;
providing a capillary made of a material with a second melting temperature in such a way that the capillary surrounds at least regions of the sensor region of the optical waveguide, and that a securing region of the capillary is arranged at a distance from the sensor region, wherein the second melting temperature is lower than the first melting temperature, wherein the temperature sensor element is arranged in an end region of the optical waveguide, and the end region is inserted into the capillary so that an end of the capillary is exposed;
securing the securing region of the capillary to the optical waveguide, involving a heating of the securing region of the capillary to a heating temperature that is equal to or higher than the second melting temperature;
heating the exposed end of the capillary to a heating temperature that is equal to or higher than the second melting temperature.

2. The securing method according to claim 1, wherein the heating temperature is lower than the first melting temperature.

3. The securing method according to claim 1, wherein the securing comprises:
heating the securing region to the heating temperature for a predetermined period of time; and
allowing the securing region to cool down.

4. The securing method according to claim 1, wherein the securing comprises:
heating the securing region to the heating temperature, wherein the heating temperature is equal to or higher than the first melting temperature, for a predetermined duration of time, wherein the predetermined duration of time is selected such that the material of the optical waveguide during securing is heated to a temperature that is lower than the first melting temperature; and
allowing the securing region to cool down.

5. The securing method according to claim 3, wherein the securing further comprises:
temporarily fixing the securing region relative to at least the axial direction of the optical waveguide prior to heating; and
after allowing to cool down, the fixing is released.

6. The securing method according to claim 3,
wherein the predetermined duration of time is at least so long that at a given diameter, a given material thickness and a given elongation of the securing region in the axial direction, the material of the capillary melts in the securing region, and wherein the predetermined duration of time is at maximum so long that the material of the optical waveguide remains in the non-molten state.

7. The securing method according to claim 3,
wherein the predetermined duration of time is at maximum so long that a region of the capillary surrounding the sensor region of the optical waveguide remains in the non-molten state.

8. The securing method according to claim 1,
wherein the securing region of the capillary is provided to be circumferential around an axis of the capillary, and wherein, after securing, the securing region circumferentially abuts against the peripheral surface of the optical waveguide in at least one manner selected from the group consisting of a friction-fit manner and/a circumferentially sealing manner.

9. The securing method according to claim 1,
wherein the securing region of the capillary has at least one axial elongation which is suitable to withstand a predetermined force in the axial direction between the capillary and the optical waveguide after securing.

10. A securing device, comprising:
an insertion region for the capillary surrounding a sensor region of an optical waveguide at least in regions, wherein the capillary comprises a securing region that can be arranged at a distance from the sensor region of the optical waveguide;
a detector configured to detect a marking on the capillary which is provided on the capillary in order to indicate the securing region of the capillary;
a heating region configured to heat the securing region of the capillary.

11. Use of a securing device,
the securing device, comprising:
an insertion region for the capillary surrounding a sensor region of an optical waveguide at least in regions, wherein the capillary comprises a securing region that can be arranged at a distance from the sensor region of the optical waveguide;
a detector configured to detect a marking on the capillary which is provided on the capillary in order to indicate the securing region of the capillary; and
a heating region configured to heat the securing region of the capillary,
for carrying out a securing method,
the securing method, comprising:
providing an optical waveguide made of a material with a first melting temperature, wherein a sensor region of the optical waveguide comprises at least one integrated temperature sensor element;
providing a capillary made of a material with a second melting temperature in such a way that the capillary surrounds at least regions of the sensor region of the optical waveguide, and that a securing region of the capillary is arranged at a distance from the sensor region, wherein the second melting temperature is lower than the first melting temperature, wherein the temperature sensor element is arranged in an end region of the optical waveguide, and the end region is inserted into the capillary so that an end of the capillary is exposed;
securing the securing region of the capillary to the optical waveguide, involving a heating of the securing region of the capillary to a heating temperature that is equal to or higher than the second melting temperature;
heating the exposed end of the capillary to a heating temperature that is equal to or higher than the second melting temperature.

12. A temperature sensor, comprising an optical waveguide having at least one integrated temperature sensor element, wherein the temperature sensor can be obtained by a securing method, the securing method, comprising:
providing an optical waveguide made of a material with a first melting temperature, wherein a sensor region of the optical waveguide comprises at least one integrated temperature sensor element;
providing a capillary made of a material with a second melting temperature in such a way that the capillary surrounds at least regions of the sensor region of the optical waveguide, and that a securing region of the capillary is arranged at a distance from the sensor region, wherein the second melting temperature is lower than the first melting temperature, wherein the temperature sensor element is arranged in an end region of the optical waveguide, and the end region is inserted into the capillary so that an end of the capillary is exposed;
securing the securing region of the capillary to the optical waveguide, involving a heating of the securing region of the capillary to a heating temperature that is equal to or higher than the second melting temperature;
heating the exposed end of the capillary to a heating temperature that is equal to or higher than the second melting temperature.

13. The securing device of claim 10, wherein the heating region is configured to heat the securing region of the capillary automatically for a predetermined duration of time when the detector detects the marking.
